(19) United States
(12) Patent Application Publication
(10) Pub. No.: US 2023/0162758 A1
(43) Pub. Date: May 25, 2023

(54) SYSTEMS AND METHODS FOR SPEECH ENHANCEMENT USING ATTENTION MASKING AND END TO END NEURAL NETWORKS

(71) Applicant: Massachusetts Institute of Technology, Cambridge, MA (US)

(72) Inventors: Bengt J. Borgstrom, Lexington, MA (US); Michael S. Brandstein, Acton, MA (US)

(21) Appl. No.: 17/991,473

(22) Filed: Nov. 21, 2022

Related U.S. Application Data
(60) Provisional application No. 63/281,450, filed on Nov. 19, 2021.

(51) Int. Cl. G10L 25/84; G10L 25/30; G10L 25/24

(52) U.S. Cl. CPC G10L 25/84; G10L 25/30; G10L 25/24

(57) ABSTRACT

A neural network-based end-to-end single-channel speech enhancement system designed for joint suppression of noise and reverberation, which can include attention masking. The neural network architecture can contain both an enhancement and an autoencoder path, so that disabling the masking mechanism causes reconstruction of the input speech signal. The autoencoder path and the enhancement can be simultaneously trained using a loss function that includes a perceptually-motivated waveform distance measure. Examples enable dynamic control of the level of suppression applied via a minimum gain level. A novel loss function can be utilized to simultaneously train both the enhancement and the autoencoder paths, which includes a perceptually-motivated waveform distance measure. Examples provide significant levels of noise suppression while maintaining high speech quality. Examples can also improve the performance of automated speech systems, such as speaker and language recognition, when used as a pre-processing step.

### CROSS-REFERENCE TO RELATED APPLICATIONS

This application claims priority to and the benefit of U.S. Provisional Application Ser. No. 63/281,450, entitled “SYSTEMS AND METHODS FOR SPEECH ENHANCEMENT USING ATTENTION MASKING AND END TO END NEURAL NETWORKS,” and filed Nov. 19, 2021, the contents of which is incorporated by reference herein in its entirety.

### GOVERNMENT RIGHTS

This invention was made with Government support under Grant No. FA8702-15-D-0001 awarded by the Air Force Office of Scientific Research. The Government has certain rights in the invention.

### FIELD

The following disclosures relates to using end-to-end neural networks for suppressing noise and distortion in speech audio signals.

### BACKGROUND

Speech signals acquired in the real world are rarely of pristine quality. In real-world applications, often because of ambient environmental conditions and the location of the microphone relative to the desired talker, speech signals are typically captured in the presence of distortions such as reverberation and/or additive noise. For human listeners, this can result in increased cognitive load and reduced intelligibility. For automated applications such as speech and speaker recognition, this can lead to significant performance degradation. Speech enhancement techniques can be used to minimize the effects of these acoustic degradations. Single-channel speech enhancement aims to reduce the effects of reverberation and noise, thereby improving the quality of the output speech signal.

For several decades, single-channel speech enhancement was addressed using a statistical model-based approach. In such systems, noise suppression was performed via multiplicative masking in the spectral domain, and optimal masks were estimated through statistical inference. In some previous techniques, various statistical cost functions were optimized during mask estimation, and in others, various statistical models were assumed for modeling speech and noise as random processes. Significant progress in noise estimation methods led to impressive noise suppression performance for acoustic environments with stationary noise components. However, for highly non-stationary noise scenarios, statistical model-based approaches to speech enhancement typically result in a high level of speech distortion and musical noise artifacts.

Within the last decade, Deep Neural Networks (DNNs) have emerged as a powerful tool for regression or classification problems, and have set the state-of-the-art across a variety of tasks, e.g., within image, speech, and language processing. Initial applications of DNNs to speech enhancement used them to predict clean speech spectrograms from distorted inputs, both for task of noise suppression and suppression of reverberation. Significant performance improvements were observed relative to statistical model-based approaches.

Later applications of neural networks to speech enhancement used DNNs to estimate multiplicative masks which were used for noise suppression in the spectral domain. In some cases, feed-forward networks were utilized, but subsequent work leveraged more advanced network architectures such as Recurrent and Long Short-Term Memory (LSTM) layers. Additional details about existing speech enhancement techniques using DNNs, including a more detailed discussion of single-channel speech enhancement using a statistical model-based approach, is provided in U.S. Pat. No. 11,227,586, entitled “SYSTEMS AND METHODS FOR IMPROVING MODEL-BASED SPEECH ENHANCEMENT WITH NEURAL NETWORKS,” filed Sep. 11, 2019, and the content of which is incorporated by reference herein in its entirety.

While some works discussed the unimportance of processing short-time phase information for speech enhancement, recent work has illustrated the potential benefits of phase processing for the task. The previously discussed DNN-based enhancement approaches manipulate spectral magnitudes of the input signal, and thereby leave the short-time phase signal untouched. This motivated recent end-to-end DNN-based enhancement systems which directly process noisy time-domain speech signals and output enhanced waveforms. Many studies explored Fully Convolutional Networks (FCNs), which offer a computationally efficient framework for noise suppression in the waveform domain. More recent studies have utilized the U-Net architecture, which enables longer temporal contexts to be leveraged during end-to-end processing by including a series of downsampling blocks, followed by a series of upsampling blocks.

Training an end-to-end neural network-based speech enhancement system requires a distance measure which operates on time-domain samples. At first, the mean squared error (MSE) between the clean and enhanced waveforms was used to optimize network parameters. Recent work, however, has proposed loss functions which are perceptually motivated. These studies have proposed losses which approximate speech quality metrics such as the Perceptual Evaluation of Speech Quality (PESQ) or the Short-Time Objective Intelligibility (STOI), or use multi-component losses, which include spectral distortion measures.

Accordingly, there exists a need for end-to-end systems and methods that effectively jointly suppress noise and reverberation in speech signals captured in the wild, which could generate enhanced signals for human listening in, by way of non-limiting example, a cellular telephone, or for automated speech applications such as Automatic Speech Recognition (ASR) or Speaker Recognition.

### SUMMARY

Certain aspects of the present disclosure provide for systems Speech Enhancement via Attention Masking Network (SEAMNET), which includes an end-to-end system for joint suppression of noise and reverberation.

Examples of SEAMNET systems according to the present disclosure include a neural network-based end-to-end single-channel speech enhancement system designed for joint suppression of noise and reverberation, which examples can accomplish through attention masking. One example property of exemplary SEAMNET systems is a network architecture that contains both an enhancement and an autoencoder path, so that disabling the masking mechanism causes exemplary SEAMNET system to reconstruct the input speech signal. This allows dynamic control of the level of suppression applied by exemplary SEAMNET systems via a minimum gain level, which is not possible in other state-of-the-art approaches to end-to-end speech enhancement. A novel loss function can be utilized to simultaneously train both the enhancement and the autoencoder paths, which includes a perceptually-motivated waveform distance measure. In addition to the novel architecture, exemplary SEAMNET system can include a novel method for designing target waveforms for network training, so that joint suppression of additive noise and reverberation can be performed by an end-to-end enhancement system, which has not been previously possible. Experimental results show that exemplary SEAMNET systems outperform a variety of state-of-the-art baselines systems, both in terms of objective speech quality measures and subjective listening tests.

Example applications of SEAMNET systems according to the present disclosure include being utilized for the end task of human listening, in, by way of non-limiting example, a cellular telephone. In this case, exemplary SEAMNET system can potentially improve the intelligibility of the speech observed in acoustically adverse environments, as well as lower the cognitive load required during listening. Additionally, exemplary SEAMNET systems can be used as a pre-processing step for automated speech applications, such as automatic speech recognition, speaker recognition, and/or auditory attention decoding.

The present disclosure includes several novel contributions. For instance, a formalization of an end-to-end masking-based enhancement architecture, referred to herein to as the b-Net. A loss function that simultaneously trains both an enhancement and an autoencoder path within the overall network. A noise suppression system allowing a user to dynamically control the tradeoff between noise suppression and speech quality via a minimum gain threshold during testing. A method for designing target waveforms so that joint suppression of noise and reverberation can be performed in an end-to-end enhancement framework. A derivation of a perceptually-motivated distance measure as an alternative to mean square-error for network training.

The present disclosure also provides experimental results comparing the performance of exemplary SEAMNET systems to state-of-the-art methods, both in terms of objective speech quality metrics and subjective listening tests, and highlights the importance of allowing dynamic user control over the inherent tradeoff between noise suppression and speech quality. Additionally, the benefit of reverberation suppression in an end-to-end system is clearly shown in objective quality measures and subjective listening. Finally, SEAMNET system according to the present disclosure offers interpretability of several internal mechanisms, and intuitive parallels are drawn to statistical model-based enhancement systems.

Certain embodiments of the present system provide significant levels of noise suppression while maintaining high speech quality, which can reduce the fatigue experienced by human listeners and may ultimately improve speech intelligibility. Embodiments of the present disclosure improve the performance of automated speech systems, such as speaker and language recognition, when used as a pre-processing step. Finally, the embodiments can be used to improve the quality of speech within communication networks.

One example of the present disclosure is a computer-implemented system for recognizing and processing speech that includes a processor configured to execute an end-to-end neural network trained to detect speech in the presence of noise and distortion. The end-to-end neural network is configured to receive an input waveform containing speech and output an enhanced waveform.

The end-to-end neural network can define a b-Net structure that can include an encoder, a mask estimator, and/or a decoder. The encoder can be configured to map the input waveform into a sequence of input embeddings in which speech signal components and non-speech signal components are separable via a scaling procedure. The mask estimator can be configured to generate a sequence of multiplicative attention masks, while the b-Net structure can be configured to utilize the multiplicative attention masks to create a sequence of enhanced embeddings from the sequence of input embeddings. The decoder can be configured to synthesize an output waveform based on the sequence of enhanced embeddings. The neural network can include an autoencoder path and an enhancement path. The autoencoder path can include the encoder and decoder, while the enhancement path can include the encoder, the mask estimator, and the decoder, and the neural network can be configured to receive an input minimum gain that adjusts the relative influence between the autoencoder path and the enhancement path on the enhanced waveform. In some example, the encoder and/or the decoder can include filter-banks configured to have non-uniform time-frequency partitioning.

The end-to-end neural network can be configured to process two or more input waveforms and output a corresponding enhanced waveform for each of the two or more input waveform. Further, the mask estimator can include a DNN path for each of the two or more input waveforms with shared layers between each path. In some examples, the encoder can include a single 1-dimensional convolutional neural network (CNN) layer with a plurality of filters and rectified linear activation functions. In some examples, the enhanced embeddings can be generated as element-wise products of the input embeddings and the estimated masks. The decoder can include a single 1-dimensional Transpose-CNN layer with an output filter configured to mimic overlap-and-add synthesis. The mask estimator can include a cepstral extraction network configured to cepstral normalize an output from the encoder. In some examples, the cepstral extraction network can be configured to perform feature normalization and can define a trainable extraction process that can include a log operator and a 1×1 CNN layer.

In some examples, the mask estimator can include a multi-layer fully convolutional network (FCN). The FCN can include a series of convolutional blocks. Each series can include a CNN filter process, a batch normalization process, an activation process, and/or a squeeze and excitation network process (SENet). In some embodiments, the mask estimator can include a sequence of FCNs arranged as time-delay neural network (TDNN). In some embodiments, the mask estimator can include a plurality of FCNs arranged as a U-Net architecture. In some embodiments, the mask estimator can include a frame-level voice activity detector layer.

Examples of the end-to-end neural network can be trained to estimate clean speech by minimizing a first cost function representing a distance between the output and an underlying clean speech signal. In some examples, the end-to-end neural network can be trained as an autoencoder to reconstruct the noisy input speech by minimizing a second cost function representing a distance between the input speech and the enhanced speech. The end-to-end neural network can be trained to restrict enhancement to the mask estimator by minimizing a third cost function that represents a combination of distance between the output and an underlying clean speech signal and distance between the input speech and the enhanced speech such that, when the mask estimator is disabled, the output of the end-to-end neutral network is configured to recreate input waveform. The end-to-end neural network can be trained to minimize a distance measure between a clean speech signal and reverberant-noisy speech signal using a target waveform according to Equation 16 (see below) with the majority of late reflections suppressed. The end-to-end neural network can be trained using a generalized distance measure according to Equation 20 (see below). The end-to-end neural network can be configured to be dynamically tuned via the input minimum gain threshold to control a level of noise suppression present in the enhanced waveform.

Another example of the present disclosure is a method for training a neural network for detecting the presence of speech that includes constructing an end-to-end neural network configured to receive an input waveform containing speech and output an enhanced waveform. The neural network includes an autoencoder path and an enhancement path. The autoencoder path includes an encoder and a decoder, while the enhancement path includes the encoder, a mask estimator, and the decoder. The neural network is configured to receive an input minimum gain that adjusts the relative influence between the autoencoder path and the enhancement path on the enhanced waveform. The method further includes simultaneously training both the autoencoder path and the enhancement path using a loss function that includes a perceptually-motivated waveform distance measure.

The training method can further include training the neural network to estimate clean speech by minimizing a first cost function representing a distance between the output and an underlying clean speech signal. Further, the training method can include training the neural network as an autoencoder to reconstruct the noisy input speech by minimizing a second cost function representing a distance between the input speech and the enhanced speech. Still further, the training method can include training the neural network to restrict enhancement to the mask estimator by minimizing a third cost function that represents a combination of distance between the output and an underlying clean speech signal and distance between the input speech and the enhanced speech such that, when the mask estimator is disabled, the output of the end-to-end neutral network can be configured to recreate input waveform.

In at least some examples, the action of simultaneously training both the autoencoder path and the enhancement path can include minimizing a distance measure between a clean speech signal and reverberant-noisy speech signal using a target waveform according to Equation 16 (see below) with the majority of late reflections suppressed.

### BRIEF DESCRIPTION OF DRAWINGS

This disclosure will be more fully understood from the following detailed description taken in conjunction with the accompanying drawings, in which:

FIG. 1A is block diagram representation of one embodiment of a prior art speech enhancement system;

FIG. 1B is a block diagram representation of one exemplary embodiment of a speech enhancement system of the present disclosure;

FIG. 2A is a block diagram representation of one exemplary embodiment of a speech enhancement system of the present disclosure;

FIG. 2B is a block diagram representation of one exemplary embodiment of a speech enhancement system of the present disclosure;

FIG. 2C is a block diagram representation of one exemplary embodiment of a speech enhancement system of the present disclosure;

FIG. 3A is a block diagram representation of one exemplary embodiment of a speech enhancement system of the present disclosure;

FIGS. 3B-3F illustrate spectrograms representing processing steps of the system of FIG. 3A;

FIG. 4A is a block diagram representation of one exemplary embodiment of a b-Net architecture of the present disclosure;

FIG. 4B is a block diagram representation of one exemplary embodiment of a mask estimation network of the present disclosure;

FIG. 4C is a block diagram representation of one exemplary embodiment of a cepstral extraction network of the present disclosure;

FIG. 4D is a block diagram representation of one exemplary embodiment of a generalized convolution block within the mask estimation fully convolutional network (FCN) of the present disclosure;

FIG. 5 illustrates spectrograms of a target waveform for joint suppression of reverberation and additive noise;

FIG. 6 is a graph of the frequency responses of the decoder synthesis filters from a narrowband speech enhancement system of the present disclosure;

FIG. 7 is an illustration of different channels of an example decoder synthesis filters from an example of a narrowband speech enhancement system of the present disclosure;

FIGS. 8A-8H illustrate spectrograms according to an example of a processing chain of a speech enhancement system of the present disclosure;

FIG. 9A is a diagrammatic illustration of a fixed time-frequency partition of an example encoder for use in speech enhancement systems of the present disclosure;

FIG. 9B is a diagrammatic illustration of a multi-resolution frequency partition of an example encoder for use in speech enhancement systems of the present disclosure;

FIG. 10 is a diagrammatic illustration of another example mask estimator using a U-Net that includes a succession downsampling-upsampling fully-connected networks for use in speech enhancement systems of the present disclosure;

FIG. 11 is a diagrammatic illustration of an example speech enhancement system with integrated stereo processing of two channels; and

FIG. 12 is a block diagram of one exemplary embodiment of a computer system for use in conjunction with the present disclosures.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-numbered components and/or like-named components of various embodiments generally have similar features when those components are of a similar nature and/or serve a similar purpose, unless otherwise noted or otherwise understood by a person skilled in the art.

Overview

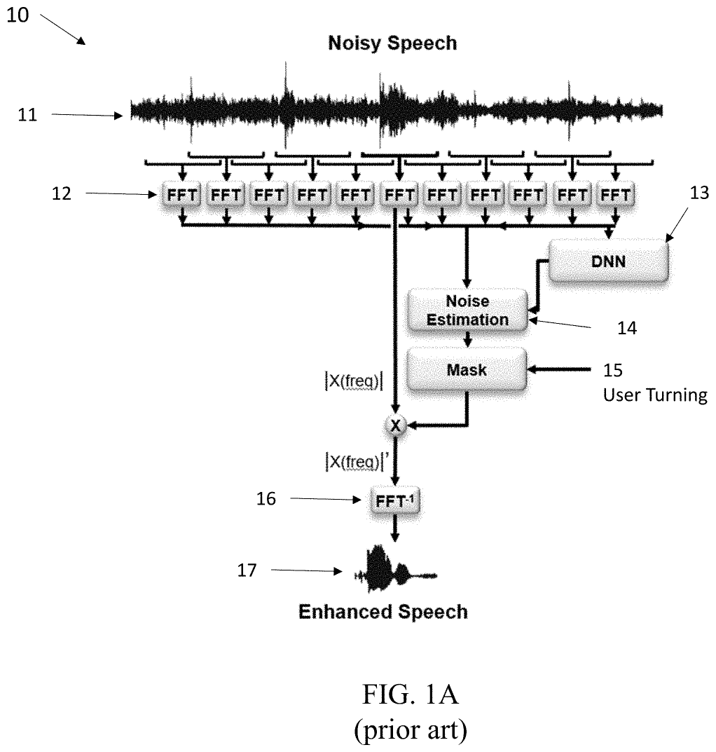

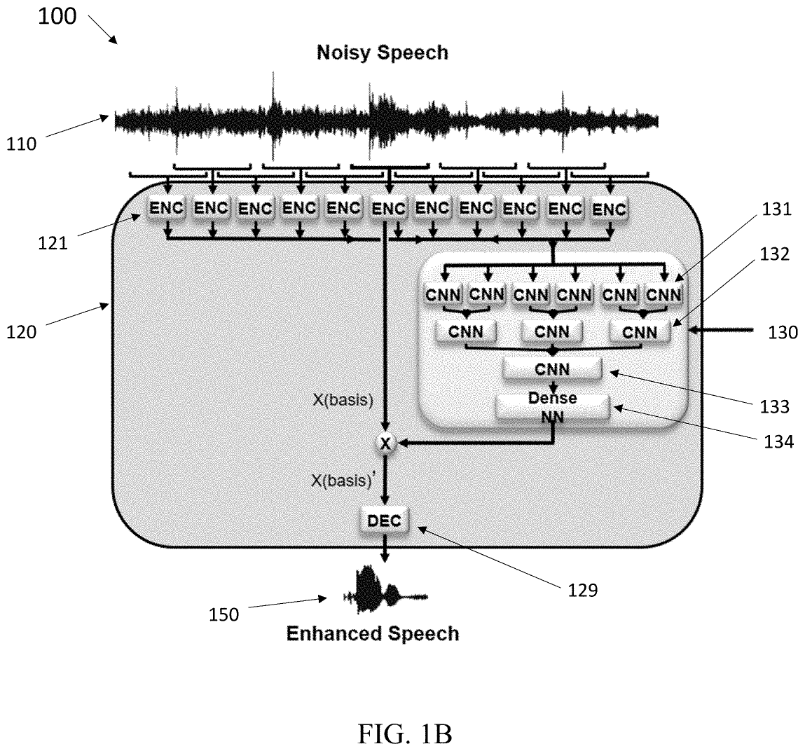

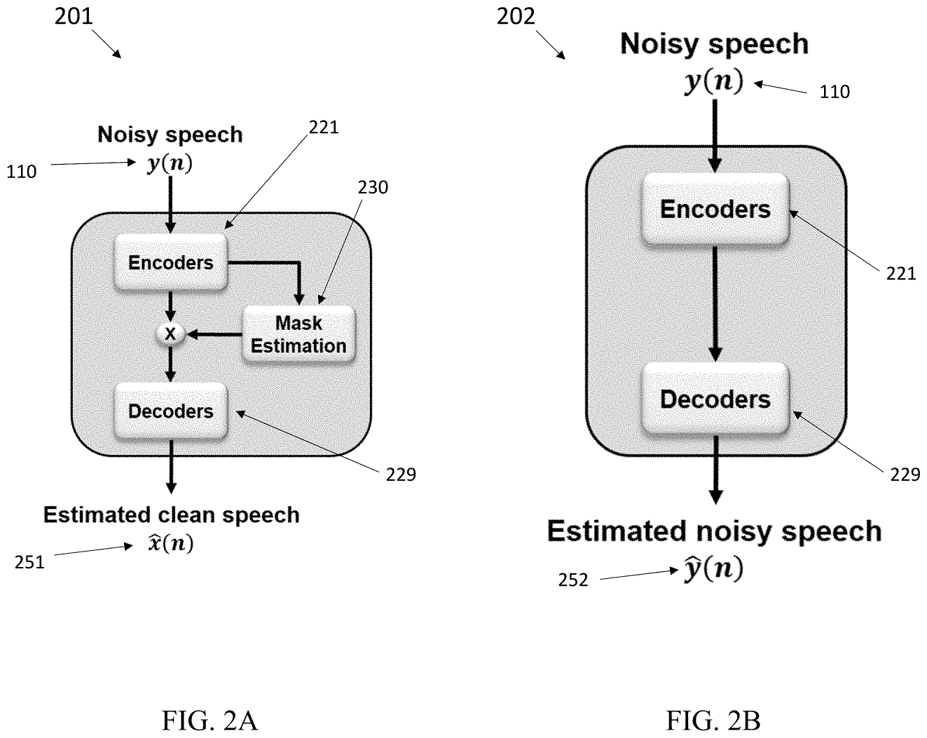

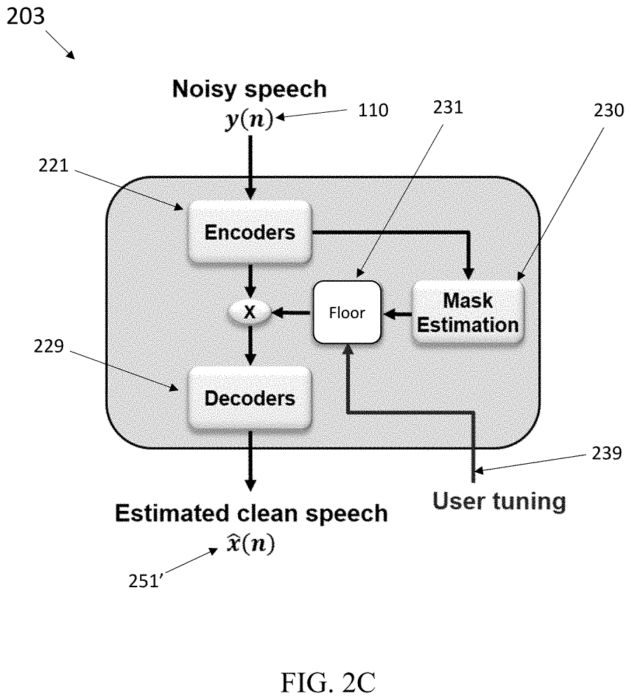

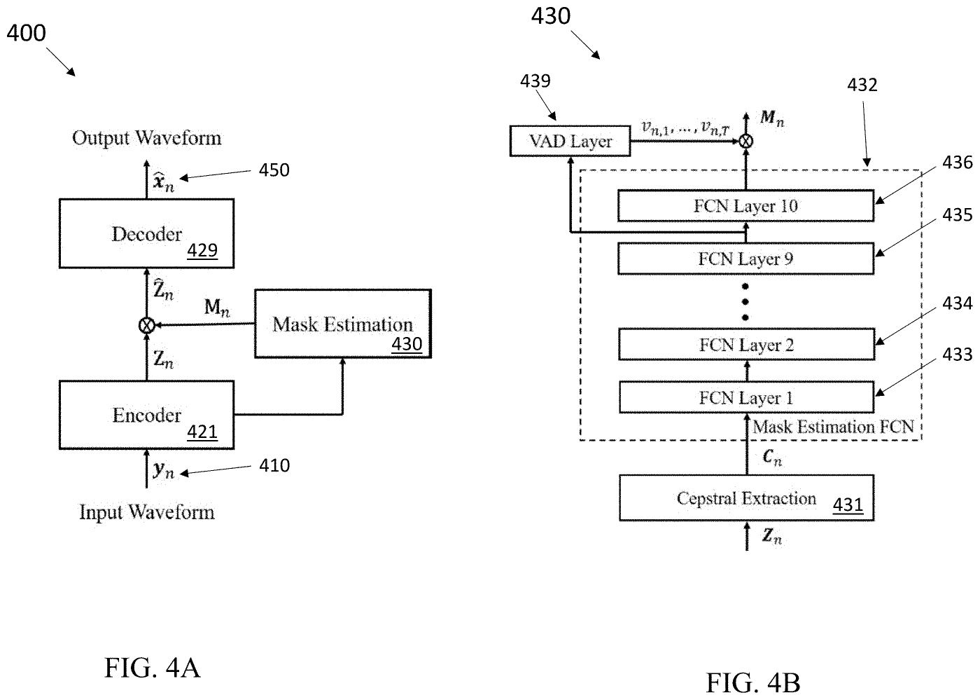

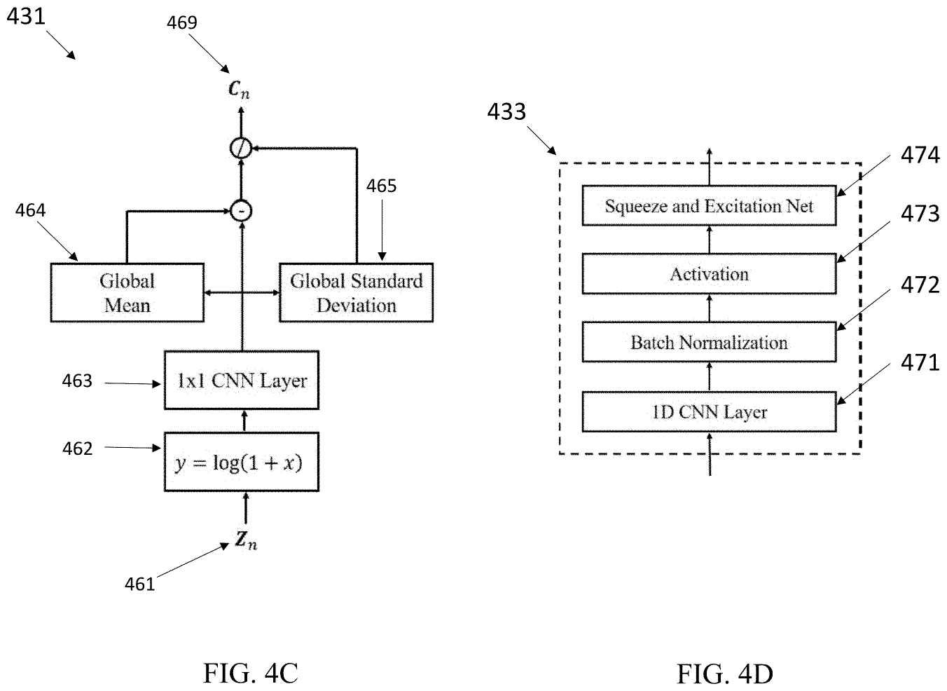

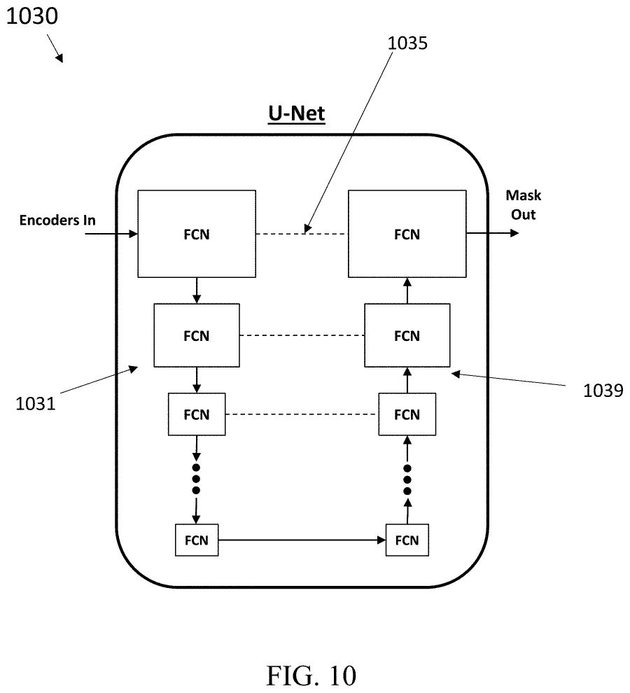

Existing DNN approaches for speech enhancement, such as that shown in FIG. 1A, provided a significant improvement over statistical-based methods, but they do not fully exploit the full capabilities of modern neural networks. The existing DNN system 10 of FIG. 1A is configured to receive a noisy speech signal 11 as an input and return an enhanced speech 17 as an output. Such prior art systems include Fast Fourier transforms 12 (FFTs), a Deep Neural Network 13 (DNN), a noise estimator 14, a mask generator 15, and an inverse FFT 16. Examples of the present disclosure include a new system for speech enhancement that is referred to herein as Speech Enhancement via Attention Masking Network (SEAMNET), examples of which include an end-to-end system 100 for joint suppression of noise and reverberation. One example of a SEAMNET system s shown in FIG. 1B and example SEAMNET systems include a number of improvements over existing DNN approaches. First, the underlying Fourier analysis was addressed. In example SEAMNET systems Fast Fourier transforms (FFTs) are replaced with a set of learnable encoders 121 and decoders 129. While FFTs have some desirable properties, they are not necessarily the optimal embedding space for separating speech from noise. Additionally, by using only the spectral magnitudes, there is no way to exploit signal phase. Examples of the SEAMNET system include new encoder 121 and decoder 129 filters that implicitly utilize both magnitude and phase from the input speech signal 110 in a more generalized manner and can potentially learn a transformational embedding that is specifically advantageous for this speech enhancement application. Example SEAMNET systems can replace speech activity DNN and noise estimation elements with a unified mask generation network 130. In some example, this mask generation neural network can be a time-delay neural network (TDNN, as shown in more detail in FIGS. 4B and 10A)) or a U-Net neural network (as shown in more detail in FIG. 10B). TDNN examples can contain convolutional layers 131, 132, 133 that attempt to capture the time evolution of the encoder outputs. Example TDNNs can then be capped off with a few fully-connected layers 134 to produce the desired mask scalings. A user-tuning module (as shown in FIG. 2C) can control the degree of noise attenuation. Finally, all the various components, including but not necessarily limited to the encoder(s) 121, the mask estimator(s) 130, and the decoder(s) 129, can be trained as one. Everything can be jointly optimized with the goal of transforming the noisy time series 110 into the clean speech signal 150.

As mentioned earlier, conventional enhancement methods often rely on user tuning to control the tradeoff between noise suppression and speech quality. Turning up the enhancement to suppress more noise, but typically at the cost of some speech distortion, and turning down the suppression leads to fewer distortions, but at the cost of more residual noise. However, in enhancement systems trained in an end-to-end manner, it may be difficult to interpret the internal components of the network. It then becomes very difficult to tune the network in an intuitive way. Examples of SEAMNET according to the present disclosure, however, can be trained in way that retain the ability to fine tune the network. First, example SEAMNET system can be trained to estimate clean speech by minimizing the distance between the network output and the underlying clean speech signal. FIG. 2A shows an example SEAMNET system 201 that includes encoders 221, decoders 229, and a mask estimation network 230 can be trained to estimate clean speech 251 from a noisy speed input 110 by minimizing a distance measure, C(x(n),\hat{x}(n)), which represents the distance between the network output 251 and the underlying clean speech signal present in the noisy speech signal 110. If masking is disabled, as shown in the example system configured 202 of FIG. 2B, the example SEAMNET system can be trained as an autoencoder to reconstruct the noisy input speech 252 by minimizing C(y(n),ŷ(n)), a cost function that can represent the distance between the input speech 110 and the reconstructed speech 252.

The costs can be combined, as shown in the example SEAMNET system 203 of FIG. 2C, where all enhancement is restricted to the masking mechanism, C(x(n),\hat{x}(n))+C(y(n),ŷ(n)). If a SEAMNET system is trained with this composite cost, it can learn to restrict all enhancement to the masking mechanism. That is, all changes to the input signal 110 can happen in the multiplication with the mask provided by the mast estimator 230, and not in the encoders 221 or decoders 229. In this way, once the SEAMNET system 203 is fully trained, a floor operator 231 can be inserted into the network to allow users to dynamically tune the network during testing by providing a minimum masking gain (e.g., floor level 239). As an illustrative example, if the user provides a floor level 239 of 1, this will effectively disable any enhancement.

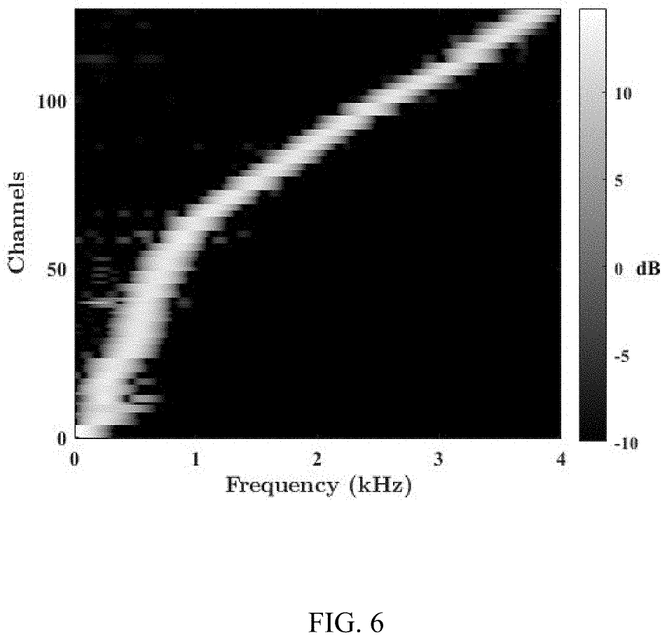

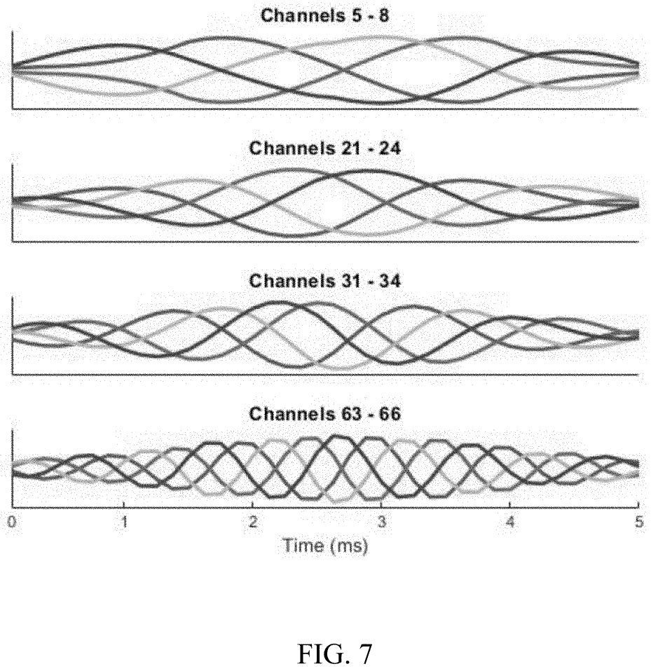

Even so, this type of black-box training can be difficult. In order to look at what the system was learning, the trained encoders 221 and decoders 229 can be observed and are intuitively satisfying from a speech science perspective. An example of frequency responses of decoder filters are shown in FIG. 6. Essentially, the filters can be well localized in time and frequency with center frequencies that follow a roughly log relationship and phases that can be evenly distributed. These are properties akin to a wavelet decomposition. From a speech processing standpoint, they can have much in common with Mel-frequency features. The plots of FIG. 7 provide some examples of decoder waveforms. In FIG. 7, channels 5-8 can be considered fairly low frequency. Then the filter frequency and filter time resolution can progress upward with channel number.

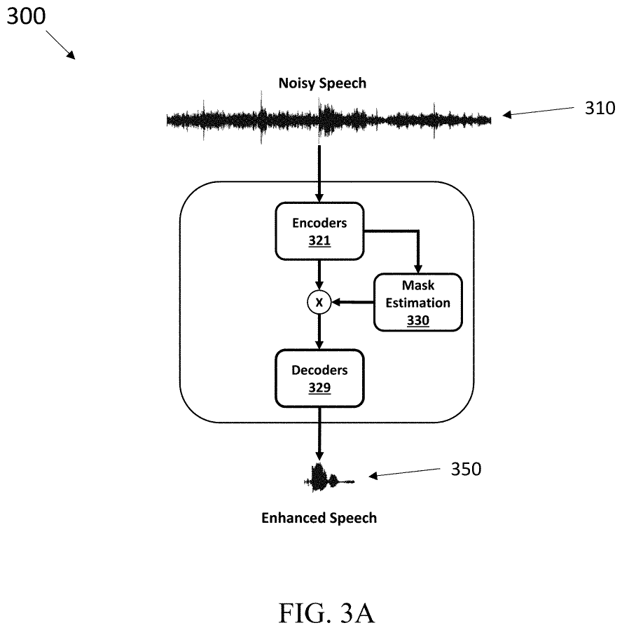

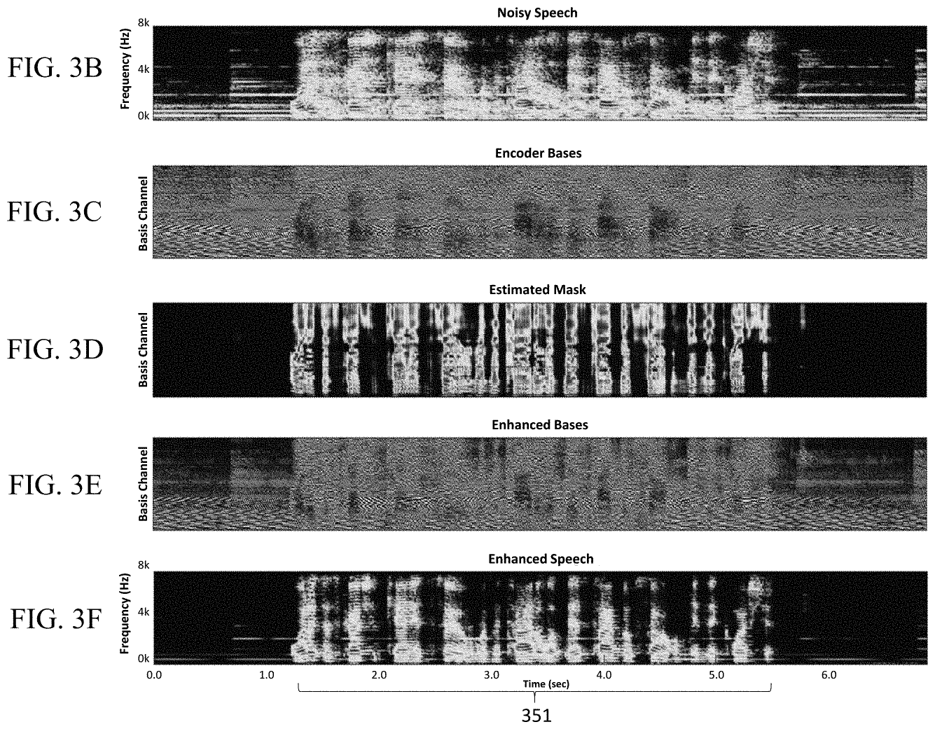

FIG. 3A shows an example system 300 of the full SEAMNET processing chain, with the plot of FIG. 3B showing the spectrogram of a noisy speech 310 input signal processed using an implementation of the example system 300 of FIG. 3A. The plot of FIG. 3C shows the output of the encoders 321, followed by a plot of the learned mask shown in FIG. 3D of the mask estimation 330, and a plot, in FIG. 3E, of the enhanced bases that can be used to generate the cleaned up speech using the decoders 329. FIG. 3F is a plot of the enhanced speech 350 output of the system 300 for the noisy speech 310 input. Comparing the spectrograms of FIGS. 3B and 3F illustrates that noise components have been removed from the beginning and end of the sample. In the speech region 351, it can be seen that the detailed noise components have been separated from the speech.

Finally, to evaluate the relative and absolute performance of example SEAMNET enhancement systems in the speech field, there are a number of quantitative measures available that can roughly correlate with listener perception. Examples of the present SEAMNET system can be evaluated with a number of these metrics, with a comparison between an existing DNN-based system and example SEAMNET systems demonstrating a clear advantage. Examples of SEAMNET systems can also be compared to a number of other recent neural-network based enhancement systems, and examples of SEAMNET can perform on par or better than the bulk of neural-network based enhancement systems.

While objective speech quality metrics can be useful, in the end it is often how good the speech sounds. In conjunction with the present disclosures, informal listening experiments were conducted where participants were played various versions of processed noisy speech and were asked to grade the signals with respect to both overall quality and intelligibility. In a first experiment, signals processed with an example SEAMNET were played at varying maximum attenuation levels (these are levels that the user can tune during testing). It was observed that the reported quality score increases as the attenuation level increases. That is, as the enhancement becomes more aggressive, the perceived quality improves, but saturates at about 25 dB. Examples of SEAMNET are observed to maintain the intelligibility score of the unprocessed signal up to about 25 dB, but a significant drop is seen at about 40 dB. This experiment demonstrates how important the user tuning can be in navigating the tradeoff between noise suppression and speech quality. In another experiment, an example SEAMNET was compared with a DNN-based solution and SEAMNET was observed to provide a significant improvement in reported quality score. Additionally, examples of SEAMNET can maintain the intelligibility of the unprocessed signal, while the DNN-based system shows a significant drop.

b-Net Structure and SEAMNET Architecture

In this section, examples of the SEAMNET architecture are presented in more detail. Specifically, examples of the enhancement path, autoencoder path, and mask estimation network are defined.

The Enhancement Path

Recent studies on end-to-end DNN-based speech enhancement systems have utilized the fully convolutional networks (FCNs) and U-Net architectures. The present example instead explores the b-Net structure illustrated in FIG. 4A, for the purpose of single-channel end-to-end speech enhancement. However, as discussed in more detail below, examples of the present disclosure include the use of a U-Net architecture. Returning to FIG. 4A,® denotes the Hadamard product. In FIG. 4A, an example b-Net SEAMNET system 400 includes an encoder 421 receiving an input waveform 410, a mask estimation network 430, and a decoder 429 reconstructing an output waveform 450. The input waveform 410 can be a noisy and/or reverberant speech waveform, as defined in Equation 1:

yₙ=[y(n), . . . ,y(n+D−1)]^{T}, (Equation 1)

Where D is the duration of the input signal 410 in samples, xₙ, denotes the underlying clean speech waveform, and is defined similarly. The b-Net system 400 first can include an encoder 421 that maps the input waveform 410 into a sequence of N_{f} embeddings Zₙ=[Z_{n, 1}, . . . , Z_{n,N}_{_{f}}], where Zₙ ∈ [symbol] ^{N}^{ₑ}^{^{×N}}^{_{f}}, according to Equation 2:

Zₙ=f_{enc}(yₙ). (Equation 2)

The intended goal of this embedding can be to project the degraded speech into a subspace in which the speech and interfering signal components are separable via a scaling procedure. A mask estimator 430 can then generate a sequence of multiplicative attention masks Mₙ=[m_{n, 1} , . . . , m_{n,N}_{_{f}}], where Mₙ ∈ [symbol] ^{N}^{ₑ}^{^{×N}}^{_{f}} according to Equation 3:

Mₙ=fₘₐₛₖ(Zₙ), (Equation 3)

and where the elements of Mₙlie within the range [0,1]. The masks can be interpreted as predicting the presence of active speech in the elements of the embedding space. Enhanced versions of the input embeddings, \hat{Z}ₙ=[\hat{z}_{n, 1}, . . . , \hat{z}_{n,T}] can be obtained as the element-wise product of the input embeddings and the estimated masks are expressed according to Equation 4:

\hat{z}_{n,t}=m_{n,t}⊗z_{n,t}. (Equation 4)

Finally, the decoder 429 can synthesize the output waveform according to Equation 5:

$$\begin{matrix}{\hat{x}}_{n} = {f}_{dec} ( {\hat{Z}}_{n} ) \\ = {f}_{dec} ( {f}_{mask} ( {f}_{enc} ( {y}_{n} ) ) ⊗ {f}_{enc} ( {y}_{n} ) ) ,\end{matrix} \qquad ( Equation 5 )$$

where \hat{x}ₙ is the enhanced speech signal. In at least some instances, the input signal 410 and output signal 450 of the example SEAMNET system 400 can be of the same duration, D. The processing chain in Equation 5 can be referred to herein as the enhancement path. The entirety of the example SEAMNET system 400 can be trained jointly using gradient descent, as described later in a SEAMNET Training section below.

In examples of the SEAMNET system, the encoder 421 can be composed of a single 1D CNN layer with Nₑ filters and ReLU activation functions, with filter dimensions Nᵢₙ and a stride of Nₛₜᵣ. The encoder 421 can be designed to mimic conventional short-time analysis of speech. The decoder 429 can be composed of a single 1D Transpose-CNN layer with an output filter dimension Nₒᵤₜ with an overlap of Nₛₜᵣ, and can be designed to mimic conventional overlap-and-add synthesis. The number of embeddings extracted from an input signal can be given by N_{f}=[D/Nₛₜᵣ].

The b-Net structure of the system 400 can be interpreted as a generalization of statistical model-based speech enhancement methods. With existing systems, the short-time magnitude spectrogram can be extracted from the noisy input wave-form, manipulated via a multiplicative mask, and the output waveform can be generated from the enhanced spectrogram through overlap-and add-synthesis using the original noisy phase signal. With the present b-Net, the Fourier analysis can be replaced by a set of generic encoder-decoder bases with non-linear activations, which can be learned jointly with the masking function, specifically for the speech enhancement task. Additionally, at least because signal phase can be implicitly incorporated into the encoder-decoder, in some instances there is no need to preserve or separately enhance the noisy phase component.

The Autoencoder Path

The attention masking module 430 can attenuate interfering signal components within the embedding space. However, a feature of the b-Net architecture can be the ability to disable this masking mechanism. The result can be an autoencoder path, as defined in Equation 6:

$$\begin{matrix}{\hat{y}}_{n} = {f}_{dec} ( {Z}_{n} ) \\ = {f}_{dec} ( {f}_{enc} ( {y}_{n} ) )\end{matrix} . \qquad ( Equation 6 )$$

Other existing speech enhancement solutions using an end-to-end architectures such as the FCN or U-Net do not contain an analogous autoencoder path. As discussed in the SEAMNET Training section below, the existence of an autoencoder path allows the user to dynamically control the level of noise suppression via a minimum gain level.

The Mask Estimation Network

In the b-Net architecture of the example system 400, enhancement can be performed via attention masking in the embedding space defined by f_{enc} so that interfering signal components can be appropriately attenuated. The goal of the mask estimation block 430 in FIG. 4A can be to generate a multiplicative mask, with outputs within the range [0,1], which can provide the desired attenuation. FIG. 4B illustrates a procedure 430 that can be used to generate the attention mask applied to the embedding features. The encoder 421 outputs (461 of FIG. 4C) can be cepstral normalized 431, forwarded though a multi-layer FCN 432 (e.g., including a plurality of FCN layers 433, 434, 435, 436, etc.), and finally scaled by a frame-level voice activity detection (VAD) term 439 to produce the attention masking elements. The individual components of the estimation procedure 430 are detailed below.

Cepstral Extraction 431: The mask estimation network 430 can include the trainable cepstral extraction process 431 illustrated in more detail in FIG. 4C, which can comprise a regularized elementwise log operator 462, followed by a 1×1 CNN Layer 463 with linear activations. In FIG. 4C, [symbol] denotes the Hadamard division operator. The number of filters in theCNN Layer is denoted by N_{c}. The CNN outputs are unit normalized across each filter by first subtracting a filter-dependent Global Mean 464 and element-wise dividing by the filter-dependent Global Standard Deviation 465. The example cepstral extraction mimics conventional cepstral processing, wherein a linear transform, e.g., the discrete cosine transform (DCT), can be applied after a log operation to de-correlate spectral features prior to further processing. However, in the provided approach, the linear transform can be trainable, and can be interpreted as de-correlating the embeddings z_{n,t}·Cₙ=[c_{n, 1}, . . . , C_{n,T}] can denote the sequence of cepstral feature vectors extracted from Zₙ, where Cₙ ∈ [symbol] ^{N}^{_{c}}^{^{×N}}^{_{f}}. In order to improve robustness to various acoustic environments, Cepstral extraction can perform feature normalization according to Equation 7:

c_{n,t}⇐(c_{n,t}−μₙ) [symbol] λₙ, (Equation 7)

with the terms of Equation 7 being able to be defined according to Equation 8:

$${μ}_{n} = \frac{1}{{N}_{f}} {\sum }_{t = 1}^{{N}_{f}} {c}_{n , t} \qquad ( Equation 8 )$$

$${λ}_{n} = {( \frac{1}{{N}_{f}} {\sum }_{t = 1}^{{N}_{f}} ( {c}_{n , t} - {μ}_{n} ) ⊗ ( {c}_{n , t} - {μ}_{n} ) )}^{1 / 2} ,$$

where the square root can be applied element-wise.

Mask Estimation: The normalized encoder features of Equation 7 can be applied to an FCN, as shown in FIG. 4D. The FCN can include a series of generalized convolutional blocks 433, each comprising a CNN filter 471, batch normalization 472, an activation 473, and a Squeeze and Excitation Network (SENet) 474. Each layer (e.g., FCN layers 433, 434, 435, 436, etc. of FIG. 4B) of the FCN can be a specific configuration of this generalized block 433. Table 1 specifies one non-limiting example set of layer parameters. In Table 1, the first three parameters (e.g., ‘Filters,’ Dimension,′ and ‘Dilation’) refer to the number of filters, filter dimension, and dilation rate of the 1-dimensional CNN layer 471. The next parameter (e.g., ‘Batch Norm.) specifies whether batch normalization is used, where ✓ and × denote inclusion and exclusion, respectively. The ‘Activation’ specifies the activation function applied. Finally, the ‘SENet’ parameter denotes the inclusion of a SENet within the generalized block. SENets extract a global channel descriptor from a batch of data, and use this descriptor to adaptively calibrate individual features. In the SENets, a reduction rate of r=10 was used.

TABLE 1
The Mask Estimation Fully Convolutional Network Architecture

| | 1D CNN Layer | | | Batch | | |
|---|---|---|---|---|---|---|
| Layer | Filters | Dimension | Dilation | Norm. | Activation | SENet |
| 1 | Nₘ | 3 | 1 | ✓ | ReLU | X |
| 2 | Nₘ | 3 | 2 | ✓ | ReLU | X |
| 3 | Nₘ | 3 | 3 | ✓ | ReLU | X |
| 4 | Nₘ | 3 | 4 | ✓ | ReLU | X |
| 5 | Nₘ | 3 | 5 | ✓ | ReLU | X |
| 6 | Nₘ | 1 | 1 | ✓ | ReLU | ✓ |
| 7 | Nₘ | 1 | 1 | ✓ | ReLU | ✓ |
| 8 | Nₘ | 1 | 1 | ✓ | ReLU | ✓ |
| 9 | Nₘ | 1 | 1 | ✓ | ReLU | ✓ |
| 10 | Nₑ | 1 | 1 | X | Sigmoid | X |

As can be observed in Table 1, the first five layers exhibit increasing filter dilation rates, allowing the FCN to summarize increasing temporal contexts. The next four layers apply 1×1 CNN layers, and can be interpreted as improving the discriminative power of the overall network. Finally, the FCN can include a layer with channel-wise sigmoid activations, providing outputs within the range [0, 1], which are appropriate for multiplicative masking. Let h_{n,t} ∈ [symbol] ^{N}^{ₘ} denote the output vector of the 9^{th} layer in Table 1, and let Wₘₐₛₖ ∈ [symbol] ^{N}^{ₘ}^{^{×N}}^{ₑ} and bₘₐₛₖ ∈ [symbol] ^{N}^{ₑ} be the weight matrix and bias vector from the 10^{th} layer. The output of the FCN is given by Equation 9:

σ(Wₘₐₛₖ^{T}h_{n,t}+bₘₐₛₖ), (Equation 9)

where σ(·) denotes the element-wise sigmoid function.

Voice Activity Detection: Whereas Equation 9 describes feature-specific masking, aspects of the present disclosure can include a layer that applies additional frame-based masking. If W_{vad} ∈ [symbol] ^{N}^{ₘ} and b_{vad} are the weight vector and bias constant of this layer, the output can be given by Equation 10:

v_{n,t}=σ(w_{vad}^{T}h_{n,t}+b_{vad}). (Equation 10)

The final mask estimation output from Equation 4 can then be expressed in terms of Equations 9 and 10 as Equation 11:

m_{n,t}=v_{n,t}·σ(Wₘₐₛₖ^{T}h_{n,t}+bₘₐₛₖ). (Equation 11)

The final mask estimation layer can be interpreted as performing frame-based voice activity detection, and applying additional attenuation of the input signal during frames that lack active speech signal.

### Example SEAMNET Training Process

In this section, an example SEAMNET training process is described. Specifically, simultaneous training of the enhancement and autoencoder paths is disclosed. Additionally, enabling joint suppression of noise and reverberation within an end-to-end system is described. Finally, a perceptually-motivated distance measure is presented.

Training The Enhancement and Autoencoder Paths

In the context of statistical model-based enhancement systems, many studies have addressed the issue of musical noise, which can occur when mask-based enhancement produces a residual noise signal containing narrowband transient components. An efficient technique for minimizing such effects can be applying a minimum gain threshold. Flooring multiplicative enhancement masks at a minimum gain, Gin, can decrease speech distortion and increase the naturalness of the residual noise signal, helping to avoid perceptually annoying artifacts. A minimum gain threshold can also allow the user to control the inherent tradeoff between speech quality and noise suppression that exists in mask-based enhancement systems.

In conventional enhancement systems, short-time spectral analysis, e.g., the STFT, can be applied to the input signal prior to masking, and the overlap-and-add method can be used to synthesize the output waveform. Using the STFT can guarantee perfect reconstruction of the input signal for Gₘᵢₙ=1.0. By minimizing the distortion associated with the autoencoder path, Equation 6, the combined effect of the encoder and decoder can approximate this perfect reconstruction property. In examples of the SEAMNET system, the ability of the autoencoder path to reconstruct the input can be ensured by using the multi-component loss defined by Equation 12:

[symbol]

=(1−α)·d(xₙ,\hat{x}ₙ)+α·d(yₙ,ŷₙ), (Equation 12)

where d(·) denotes some distance measure, \hat{x}ₙ is the output of the enhancement path from Equation 5, ŷₙ is the output of the autoencoder path from Equation 6, and a is a constant. In this way, the enhancement and autoencoder paths within SEAMNET can be simultaneously trained, and a can control the balance between the two.

The b-Net architecture can allow for a minimum gain threshold to be dynamically tuned during enhancement. The enhanced output waveform from Equation 5 can be generalized as Equation 13:

xₙ=f_{dec}(max{Mₙ,Gₘᵢₙ}⊗Zₙ), (Equation 13)

where Gₘᵢₙ can be specified by the user during testing to control the tradeoff between noise suppression and speech quality. Note that for Gₘᵢₙ=1.0, the output of the enhancement and autoencoder paths are identical, as expressed by Equation 14:

\hat{x}ₙ|Gₘᵢₙ=1.0=ŷₙ, (Equation 14)

and, for a system trained with the multi-component loss from Equation 12, setting Gₘᵢₙ=1.0 will ensure that the enhancement path output is a close following approximation to original noisy speech, as expressed by Equation 15:

\hat{x}ₙ|Gₘᵢₙ=1.0≈yₙ, (Equation 15)

This is similar to the perfect reconstruction property of conventional masking-based enhancement systems. Other end-to-end architectures, such as the FCN and U-Net, do not exhibit an analogous reconstruction property. Instead, within such systems, noise suppression is typically performed throughout network layers, and no control over the level of suppression is typically exposed to the user.

Joint Suppression of Noise and Reverberation

Some existing end-to-end speech enhancement systems have proven successful at suppressing additive noise. However, it is not believed that a study has addressed suppression of reverberation with an end-to-end system, such as provided by aspects of the present disclosure. This may be due, at least in part, to the significant phase distortion introduced by reverberation, which makes a waveform-based mapping difficult to learn. In this section, a novel method is described for designing target waveforms that allow end-to-end systems to be trained to perform joint suppression of both additive noise and reverberation.

Typically, end-to-end systems are trained with parallel data in which known clean speech is corrupted with additive noise; the system learns the inverse mapping. However, in many realistic environments, speech signals are captured in the presence of additive noise and reverberation. As mentioned above, let x(k), w(k), and y(k) denote the underlying clean, reverberated-only, and reverberant-noisy speech signals, respectively. Let X_{m,l} represent the STFT of x(k), where m and l denote frequency channel and frame index, respectively, and let W_{m,l} be defined similarly. An enhanced version of W_{m,l} can be obtained using an oracle Wiener Filter, according to Equation 16:

$${X}_{m , l}^{*} = max \{ min \{ \frac{{\vert {X}_{m , l} \vert}^{2}}{{\vert {W}_{m , l} \vert}^{2}} , {η}_{max} \} , {η}_{min} \} {W}_{m , l} , \qquad ( Equation 16 )$$

where ηₘₐₓ=1.0 and ηₘᵢₙ=0.1 can be the maximum and minimum gain limits. The corresponding waveform, x*(k), can be synthesized via the inverse STFT. The signal x*(k) then represents a version of the reverberant signal w(k) with the majority of late reflections suppressed, but with the phase distortion introduced by early reflections still present. This allows an end-to-end system, such as examples of the present SEAMNET system, to be trained to perform joint suppression of noise and reverberation by learning a mapping from y(k) to x*(k) through the minimization of some distance measure d(x*ₙ, \hat{x}ₙ).

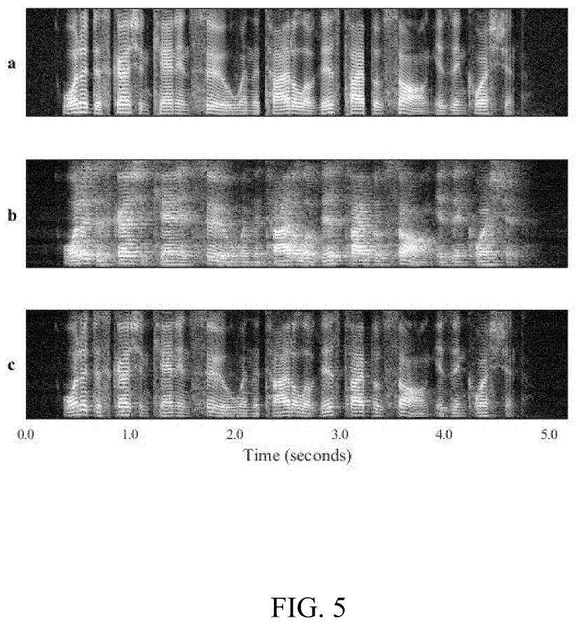

FIG. 5 is an illustrative example of a target waveform. Panel a provides the spectrogram of the clean utterance, x(k), with the transcription, “What a discussion can ensue when the title of this type of song is in question.” Panel b shows the reverberant version, w(k), corresponding to a reverberation time of 400 ms. Panel c provides the target signal, x*(k), after applying an oracle Weiner filter according to Equation 16. As can be observed in x*(k), the majority of the late reverberation can be suppressed, providing a higher quality target signal for training an end-to-end enhancement system.

Perceptually-Motivated Distance Measure

Training an end-to-end speech enhancement system, such as examples of the present SEAMNET system, can require a distance measure that operates on time-domain samples. Initial studies on end-to-end enhancement systems optimized network parameters using the mean squared error (MSE) between the output waveform, \hat{x}ₙ, and the clean waveform, xₙ, given by Equation 17:

$${d}_{MSE} ( {x}_{n} , {\hat{x}}_{n} ) = \frac{1}{D} {\sum }_{k = 1}^{D} {( {x}_{n} ( k ) - {\hat{x}}_{n} ( k ) )}^{2} . \qquad ( Equation 17 )$$

However, Equation 17 does not take into account properties of human perception of speech, and may not result in an enhanced signal that optimizes perceptual quality. While recent studies have proposed loss functions that address these issues, disclosed herein is an alternative version of MSE, which is perceptually motivated and computationally efficient.

Speech signals exhibit a steep spectral slope so that higher frequencies show a reduced dynamic range. To compensate for this, many conventional speech processing systems include a pre-emphasis filter designed to amplify the higher frequency ranges prior to further processing. Typically, pre-emphasis is implemented as a 1st-order moving average filter, according to Equation 18:

x(k)⇐x(k)−βx(k−1). (Equation 18)

Additionally, human hearing is more sensitive to the smaller waveform amplitudes within a given acoustic signal. In the context of speech signal compression, non-linear companding functions can be used to compensate for this effect during quantization. A commonly studied example is the μ-law companding function, which is expressed as Equation 19:

$${f}_{μ} ( x ( k ) ) = sign ( x ( k ) ) \frac{log ( 1 + μ \vert x ( k ) \vert )}{log ( 1 + μ )} , \qquad ( Equation 19 )$$

where μ controls the level of companding. The MSE loss from Equation 17 can be generalized to include the effects of both pre-emphasis and companding, leading to Equation 20:

$${d}_{pMSE} ( {x}_{n} , {x}_{n} ) = \frac{1}{D} {\sum }_{k = 1}^{D} {( {f}_{μ} ( {x}_{n} ( k ) - β {x}_{n} ( k - 1 ) ) - {f}_{μ} ( {\hat{x}}_{n} ( k ) - β {\hat{x}}_{n} ( k - 1 ) ) )}^{2} . \qquad ( Equation 20 )$$

Equation 20 offers a generalized distance measure that can be tuned to account for various properties of human perception. For settings β=0.0 and μ→0.0, the proposed measure can be equivalent to the standard MSE in Equation 17. The perceptually-motivated MSE from Equation 20 can be used during SEAMNET training. When joint suppression of noise and reverberation is enabled, the distance measure d_{pMSE}(x*ₙ, \hat{x}ₙ) can be used.

Experimental Results

This section outlines an example experimental procedure. The training corpus is described, and experimental results for examples of the SEAMNET system are provided in terms of objective speech quality metrics and subjective listening tests. The interpretability of various layers within examples of the SEAMNET system are then discussed.

Training Data

As discussed above, some examples of the SEAMNET system may require three-part parallel training data. A corpus of degraded speech can be designed based on clean speech from the TIMIT corpus (ISBN: 1-58563-019-5), using room impulse responses (RIRs) from the Voice-Home package and additive noise and music from the MUSAN data set (available from http://www.openslr.org/17/). Training files were created according to the following recipe: first, clean speech signals, x(k), were simulated by concatenating eight (8) randomly selected TIMIT files, with random amounts of silence between each. Additionally, randomized gains can be applied to each input file to simulate the presence of both near-field and far-field talkers. Next, a RIR can be selected from the Voice-Home set, and artificially windowed to match a target reverberation time uniformly sampled from the range [0.0 s, 0.5s], giving the reverberant version of the signal, w(k). Finally, two additive noise files can be selected from the MUSAN corpus, the first from the Free-Sound background noise subset, and the other either from the music corpus or the Free-Sound non-stationary noise subset. These files can be combined with random gains, resulting in the noise signal. The noise signal can be mixed with the reverberant speech signal to match a target SNR, with targets sampled substantially uniformly from [−2 dB, 20 dB], resulting in the reverberant and noisy signal, y(k). The duration of the training files averaged 30 s, and the total corpus contained 500 hr of data. In practice, there are several other speech, noise, and RIR libraries that are available and this paragraph describes just one possible example set.

Experimental Results

The corpus described above was used to train example SEAMNET systems in a number of experimental tests. Separate versions of the SEAMNET system can be trained for narrowband speech, fₛ=8 kHz, and wideband speech, fₛ=16 kHz. The network architecture parameters for each (e.g., narrowband and wideband speech) are summarized in Table 2. The following training parameters were used for both versions: α=0.5 for the multi-component loss in Equation 12, β=0.5 and μ=5.0 for the distance measure in Equation 20, and Gₘᵢₙ=0.0 for Equation 13, though this parameter can be dynamically tuned during testing. During an example SEAMNET training, the Adam optimizer was used for 20 epochs. The narrowband and wideband example versions of the SEAMNET system contained 4.7M and 5.1M trainable parameters, respectively.

TABLE 2
SEAMNET Architecture Example Parameters

| | System | | |
|---|---|---|---|
| Parameter | fₛ = 8 kHz | fₛ = 16 kHz | Comments |
| D | 8000 | 16000 | Corresponds to 1.0 s |
| Nᵢₙ | 240 | 480 | Corresponds to 30.0 ms |
| Nₛₜᵣ | 20 | 40 | Corresponds to 2.5 ms |
| Nₑ | 128 | 256 | |
| N_{c} | 256 | 256 | |
| Nₘ | 256 | 256 | |
| Nₒᵤₜ | 40 | 80 | Corresponds to 5.0 ms |

Objective Results

A database, such as the Voice Cloning Toolkit (VCTK) database, can include a parallel clean-corrupted speech corpus designed for training and testing enhancement methods. Both the noisy-reverberant and noise-only versions of VCTK test set can be utilized to evaluate the performance of example SEAMNET systems. Except for the results detailed in Table 5, none of the VCTK speech was included in the SEAMNET training procedure, at least in this instance. For all experiments, the minimum gain was set to Gₘᵢₙ=−25 dB.

First, an ablation study was performed to assess the effectiveness of the various components comprising example of the SEAMNET system, and objective speech quality results are provided in Table 3. Specifically, results are reported in Table 3 in terms of PESQ, STOI, segmental SNR improvement ΔSSNR, and the composite signal, background, and overall quality scores from (CSIG, CBAK, COVL, respectively). The first row of Table 3 includes results for the unprocessed input signal. Next, the second row of Table 3 can provide results for a baseline narrowband SEAMNET system, which can follow the b-Net structure from FIG. 4A, but may lack Cepstral Mean and Variance Normalization, Squeeze and Excitation Networks, and the Voice Activity Detection layer. This baseline can be trained, for example, via a conventional noise suppression approach, i.e., learning a mapping from the reverberant-noisy speech, y(k), to the reverberant signal, w(k), by minimizing the standard MSE cost function of Equation 17. The second row of Table 3 shows that an example of the baseline version of the SEAMNET system can offer performance improvements over the input signal, across the majority of the objective measures.

TABLE 3

| Systems | PESQ | STOI | ΔSSNR | CSIG | CBAK | COVL |
|---|---|---|---|---|---|---|
| Input | 2.10 | 63.73 | 0.00 | 2.276 | 1.780 | 2.078 |
| Baseline SEAMNET System | 2.28 | 73.27 | 4.86 | 2.201 | 1.977 | 2.116 |
| Reverberation-suppressed Target Waveforms | 2.47 | 77.03 | 6.57 | 2.515 | 2.264 | 2.387 |
| Cepstral Mean and Variance Normalization | 2.51 | 78.23 | 8.54 | 2.795 | 2.312 | 2.560 |
| Squeeze-and-Excitation Networks | 2.57 | 79.48 | 8.51 | 2.993 | 2.351 | 2.695 |
| Perceptual MSE Cost | 2.58 | 79.03 | 8.80 | 3.037 | 2.380 | 2.728 |
| Voice Activity Detection Masking | 2.55 | 80.96 | 9.36 | 2.717 | 2.348 | 2.541 |

In each subsequent row of Table 3 beyond the second, an additional feature has been cumulatively added to the example SEAMNET system. The third row provides objective results when the joint noise-reverberation suppression (detailed above) is introduced. Table 3 shows that joint suppression of noise and reverberation can provide significant performance improvements over the conventional training scheme, and the improvements are noticeable across all objective measures. Informal listening revealed that the proposed training method led to significantly attenuated reverberant tails, especially for files with more severe acoustic environments.

The fourth, fifth, and sixth rows of Table 3 detail the incremental results of adding the CMVN, including a SENet layer in the FCN modules, and utilizing the perceptually-motivated distance metric, respectively. Table 3 shows that the addition of each feature led to performance improvements across most of the objective measures. In informal listening tests, these features seemed to reduce residual noise, especially during periods of inactive speech.

Finally, the seventh and last row of Table 3 provides results for adding the VAD layer described above. Including the VAD layer feature provided improvements in STOI and ΔSNR, but led to performance degradation for other objective measures. During informal listening tests, the VAD layer provided further reduction of residual noise, especially during periods of inactive speech, but at the cost of some speech distortion.

Next, a comparative experiment was designed to compare the performance of an example SEAMNET system with an example of an existing state-of-the-art system, in which a recurrent neural network was used to predict a multiplicative mask in the short-time spectral magnitude domain. Further, in the existing system of the comparative experiment, the mask was trained to perform joint suppression of noise and reverberation. The noisy-reverberant version of the VCTK test set were again employed for this comparative experiment. Table 4 provides results from this comparative experiment in terms of the composite scores for signal, background, and overall quality from. Table 4 shows that examples of SEAMNET can provide significant performance improvements relative to the state-of-the-art system, for both the narrowband and wideband systems. One explanation for this improvement is ability of SEAMNET to enhance the short-time phase signal of the input, which is not possible within the STFT magnitude-only analysis-synthesis context of the state-of-the-art system.

TABLE 4

| | | | |
|---|---|---|---|
| Systems | CSIG | CBAK | COVL |

Narrowband System (fₛ = 8 kHz)

| | | | |
|---|---|---|---|
| Input | 2.276 | 1.780 | 2.078 |
| Spectral-Based | 2.671 | 2.234 | 2.483 |
| SEAMNET | 2.717 | 2.348 | 2.541 |

Wideband System (fₛ = 16 kHz)

| | | | |
|---|---|---|---|
| Input | 1.532 | 1.358 | 1.284 |
| Spectral-Based | 1.899 | 1.775 | 1.596 |
| SEAMNET | 2.182 | 1.892 | 1.780 |

Finally, a second comparative experiment was designed to compare examples of the wide-band SEAMNET system with a variety of state-of-the-art end-to-end enhancement systems. At least because prior end-to-end approaches have only addressed additive noise suppression, the noise-only version of VCTK was used as a test set for this second comparative experiment. Table 5 provides results in terms of composite quality scores for the second comparative experiment. In Table 5, Weiner represents a conventional statistical model-based systems, but the remaining baselines represent state-of-the-art, end-to-end DNN-based approaches, all of which were trained using the noisy VCTK training set. For fair comparison, in this experiment, the example SEAMNET system was trained using this set, and the system was trained in a conventional manner to learn a mapping from a waveform with additive noise to the underlying clean version. Table 5 shows that the SEAMNET system performs comparably to the baseline systems, despite not exploiting the full potential of performing joint suppression of noise and reverberation.

TABLE 5

| Systems | CSIG | CBAK | COVL |
|---|---|---|---|
| Input | 3.35 | 2.44 | 2.63 |
| Weiner | 3.23 | 2.68 | 2.67 |
| SEGAN | 3.48 | 2.94 | 2.80 |
| Wave-U-Net | 3.52 | 3.24 | 2.96 |
| Deep Feature Loss | 3.86 | 3.33 | 3.22 |
| Attention Wave-U-Net | 3.79 | 3.32 | 3.17 |
| SEAMNET | 3.87 | 3.16 | 3.23 |

Subjective Results

To further test the performance of examples of the SEAMNET system, an informal listening test was conducted to assess the perceived quality of enhanced speech. The listening test was administered in five (5)-trial sessions via a Matlab-based GUI. For each trial, the participant was presented with five (5) unlabeled versions of a randomly chosen sample from the noisy and reverberant VCTK corpus, namely: (1) the original, unprocessed version, (2) the output of the spectral-based enhancement system from the existing state-of-the-art system, (3) the output of an example of the SEAMNET system with Gₘᵢₙ=−10 dB, (4) the output of an example of the SEAMNET system with Gₘᵢₙ=−25 dB, and (5) the output of an example of the SEAMNET system with Gₘᵢₙ=−40 dB.

In the listening test, each participant was first prompted to score each of the samples listened to with respect to overall quality, and was asked to take into account the general level of noise and reverberation in the signal, the naturalness of the speech signal, and the naturalness of the residual noise. Rather than a ranking scheme, participants were asked to assign a value to each sample across a continuous scale ranging from 0 (worst) to 1 (best). They were also instructed to assign these values with regard to their relative ranking of the samples and their perceived degree of preference. Specifically, the following instructions were provided: “If two samples are perceptually very similar, please assign them a small value difference. Samples for which you have a very distinct perceptual preference should have a larger value difference.” Each participant was then prompted to score each of the samples with respect to intelligibility using a similar scale, and was asked to judge the clarity of the words in the given audio.

Results from the listening test are provided in Table 6 and Table 7. In both Table 6 and Table 7, scores are trial-normalized, and averaged across 65 total trials from 13 sessions. That is, for each trial, raw scores from the participants are linearly transformed so that the lowest and highest reported scores are mapped to 0 and 1, respectively. In both Table 6 and Table 7, results in bold denote the best result for each experiment.

TABLE 6

Gₘᵢₙ

| | Unprocessed | −10 dB | −25 dB | −40 dB |
|---|---|---|---|---|
| Overall Quality | 0.02 | 0.33 | 0.88 | 0.77 |
| Intelligibility | 0.60 | 0.67 | 0.61 | 0.44 |

Table 6 provides a study on the effect of the minimum gain Gₘᵢₙ on the perceived speech quality of the SEAMNET system example. In terms of overall quality, the Gₘᵢₙ=−25 dB setting resulted in significant performance improvements over each of the other cases. Specifically, the −25 dB setting provided a 14% relative improvement in the trial-normalized overall quality score compared to the −40 dB case, despite the more aggressive noise suppression allowed by the latter system. In terms of intelligibility, the Gₘᵢₙ=−25 dB setting maintained the intelligibility score of the unprocessed input, whereas the −40 dB case suffered a 27% relative degradation. The mildest attenuation case (−10 db) case achieved the highest perceived intelligibility, preferred over the input. While this result has yet to be confirmed by formal quantitative intelligibility tests, it does highlight the quality-intelligibility tradeoff inherent in the enhancement application. Overall, the results in Table 6 show the strong effect of the minimum gain level on the subjective speech quality of example of the SEAMNET system, and highlight the importance of allowing the listener to control Gₘᵢₙ depending on their specific focus.

TABLE 7

Enhancement System

| | Unprocessed | Spectral-Based | SEAMNET |
|---|---|---|---|
| Overall Quality | 0.02 | 0.71 | 0.88 |
| Intelligibility | 0.60 | 0.49 | 0.61 |

Table 7 provides a comparison of an example SEAMNET system with Gₘᵢₙ=−25 dB to an existing state-of-the-art spectral-based enhancement system. The baseline systems from Table 5 were not included in the listening tests at least because they were designed solely for suppression of additive noise. In terms of overall quality, the example SEAMNET system provided a significant improvement in subjective scores relative to the comparison system (e.g., Spectral-Based in Table 7). Specifically, an example SEAMNET system resulted in a 23% relative improvement in the trial-normalized overall quality score. In terms of intelligibility, it can be observed that the Spectral-Based system suffered a 18% relative performance degradation compared to the unprocessed input. The example SEAMNET system, on the other hand, maintained the intelligibility score of the unprocessed input.

Interpretability of Example SEAMNET Systems

An analysis of the learned parameters of example SEAMNET system offers some observations that are consistent with speech science intuition. For example, the encoder in the SEAMNET system can be interpreted as decomposing the input signal into an embedding space in which speech and interfering signal components are separable via masking. Similarly, the decoder in the SEAMNET system can synthesize an output waveform from the learned embedding. The behavior of examples of the SEAMNET decoder are illustrated in FIGS. 6 and 7. Specifically, FIG. 6 plots the frequency responses of the learned synthesis filters in the narrowband example of SEAMNET system, ordered by the frequencies of maximum response. It is clear from FIG. 6 that the example SEAMNET decoder learns a set of bandpass filters, and that the center frequencies of the filters follow a warped frequency scale, similar to the Mel or Bark Scales. FIG. 7 plots a subset of the synthesis filter waveforms, grouped by similar center frequencies. The SEAMNET decoder filters can be interpreted as sinusoidal signals with amplitude modulation, and can exhibit a striking similarity to wavelet filters. In the illustrated embodiment, the narrowband example of the SEAMNET system contains 128 decoder filters, each of length 40 samples, representing an overcomplete basis. From the figure, it seems that the example SEAMNET decoder exploits this overcompleteness by learning diversity with respect to phase. Within each group, the filters in FIG. 7 can show similar carrier frequency and amplitude modulation, but can differ in relative phase. Examples of the SEAMNET encoder can exhibit behavior similar to examples of the SEAMNET decoder, although the duration of the filters can be longer.

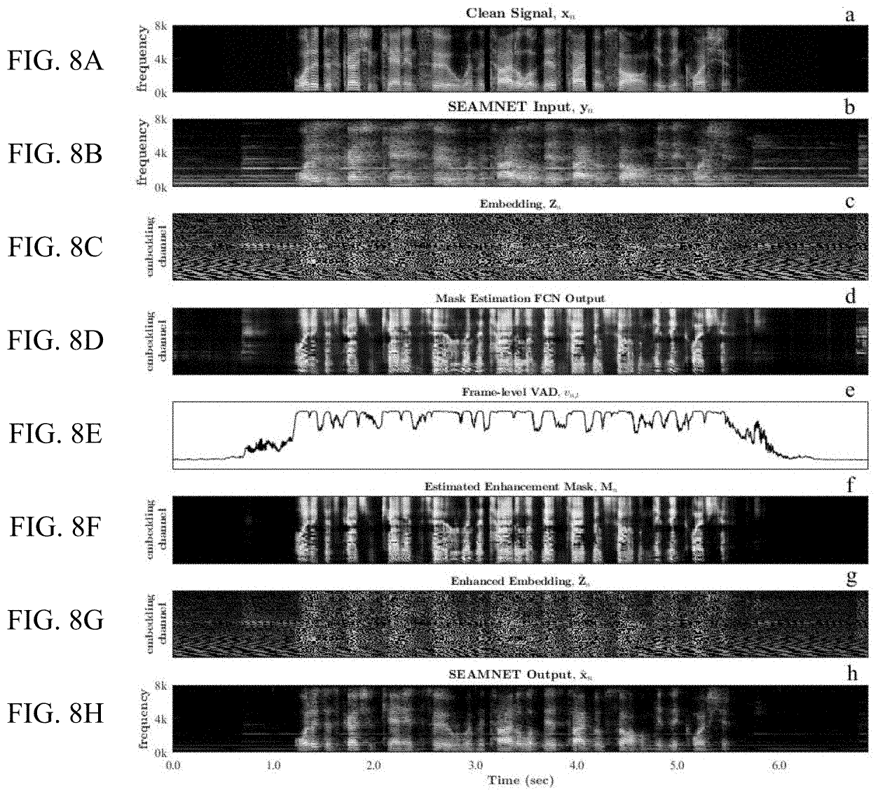

FIGS. 8A-8H provides an illustrative example of a SEAMNET system processing chain. For the sake of clarity, the spectrograms in FIGS. 8A and 8H are shown on a log scale, as are the embeddings in FIGS. 8C and 8G. The multiplicative masks in FIGS. 8D and 8F are displayed on the range [0, 1]. The VAD output in FIG. 8E is plotted on the range [−0.2, 1.2]. FIG. 8A shows the spectrogram of a clean input sentence with the transcription “What a discussion can ensue when the title of this type of song is in question.” FIG. 8B shows a reverberant and noisy version of the sentence. Reverberation was simulated using a room impulse response with a reverberation time of about 400 ms. Additive noise was simulated using a stationary background noise file and a non-stationary music file, and was mixed at an SNR of about 15 dB. Note that the speech signal, the room impulse response, and noise files were not part of the SEAMNET training set described above. FIG. 8C provides the corresponding embeddings, Zₙ, where elements have been ordered according to the frequencies of maximum response of the encoder filters. FIG. 8D illustrates the output of the mask estimation FCN from Equation 9, and FIG. 8E shows the output of the VAD layer from Equation 10. The final mask from Equation 11 is shown in FIG. 8F. FIG. 8G provides the enhanced embedding, Z\hat{ }n, and FIG. 8H shows the spectrogram of the enhanced waveform from Equation 13.

Various observations can be made from FIGS. 8A-8H. First, the embeddings in FIG. 8C show obvious correlation to the conventional spectrogram in FIG. 8B, although the embeddings encode both the short-time spectral magnitude and phase signals of the input waveform. Next, the estimated mask in FIG. 8F provides intuitive value, predicting the presence of active speech in the embedding space. Additionally, the VAD output in FIG. 8E clearly predicts temporal regions of active speech. In the example, the VAD layer is able to refine the output of the mask estimation FCN in FIG. 8D, attenuating false alarms of active speech, and yielding a more accurate final mask in FIG. 8F. Examples of this occur at 0.60 s-0.80 s, 5.70 s-5.80 s, and 6.80 s-6.90 s. Finally, the output spectrogram shows the ability of example SEAMNET systems to perform joint suppression of noise and reverberation. The challenging, non-stationary music can be suppressed well throughout the duration of the input. Additionally, example SEAMNET system can be capable of successfully attenuating much of the late reverberation, which can be observed as smearing of active speech energy in FIG. 8B. Examples of this occur at least in approximately the following ranges: about 1.45 s to about 1.50 s, about 1.95 s to about 2.05 s, and about 4.05 s to about 4.10 s.

Certain aspects of the Speech Enhancement via Attention Masking Network, an end-to-end system for joint suppression of noise and reverberation, can be summarized as follows: First, b-Net, an end-to-end mask-based enhancement architecture. The explicit masking function in the b-Net architecture enables a user to dynamically control the tradeoff between noise suppression and speech quality via a minimum gain threshold. Secondly, a loss function, which can simultaneously train both an enhancement and an autoencoder path within the overall network. Finally, a method for designing target signals during system training so that joint suppression of noise and reverberation can be performed within an end-to-end enhancement system. The experimental results show example systems to outperform state-of-the-art methods, both in terms of objective speech quality metrics and subjective listening tests.

While the spectrograms of FIGS. 3B-3F, 5, and 8A-8H are illustrated in grayscale, a person skilled in the art will recognize the grayscale spectrograms may actually be, and often preferably are, in color in practice, where the low amplitude regions are colored blue, and increasing amplitudes are shown as shifts from green to yellow and then to red, by way of non-limiting example.

SEAMNET Algorithm Improvements

A number of improvements to the basic SEAMNET system described above have been developed as well. The following sections detail three of architecture/algorithm changes that can improve the objective performance of SEAMNET systems, each of which improve the objective performance of SEAMNET systems: (1) multi resolution time-frequency portioned encoder and decoder filters, (2) a U-Net mask estimation network, and (3) multi-channel processing with shared masking layers. In addition to these structural changes, improvements to the objective performance of SEAMNET systems were also developed by expanding the training data used by, for example, adding hundreds of hours of noise samples to the training data and increasing the impulse response variability. This expansion and diversification of the training data, in addition to the structural changes detailed below, substantially improved the objective performance of examples of the SEAMNET system. Table 8 shows a comparison of between a new unprocessed signal, a SEAMNET system configured without these structural changes and improved training data, and finally a SEAMNET system (Improved SEAMNET′) using all of these structural improvements and expanded training data.

The SEAMNET improvements were designed to enhance the system's ability to represent the input acoustic signal in a perceptually relevant embedding space, and to increase the robustness of the system to varying and difficult acoustic environments. The results in Table 8 were obtained on the Voice Cloning Toolkit (VCTK) test corpus, which contains speech with synthetically added reverberation and noise. The test corpus includes signals sampled at 16 kHz.and none of the test corpus material was included in the training.

TABLE 8
Objective Measures of SEAMNET Algorithm Improvements

| System | PESQ | CSIG | CBAK | COVL |
|---|---|---|---|---|
| Unprocessed | 1.99 | 1.553 | 1.357 | 1.294 |
| SEAMNET | 2.46 | 2.182 | 1.892 | 1.78 |
| Improved SEAMNET | 2.64 | 2.437 | 1.98 | 2.023 |

Multi-Resolution Encoders and Decoders

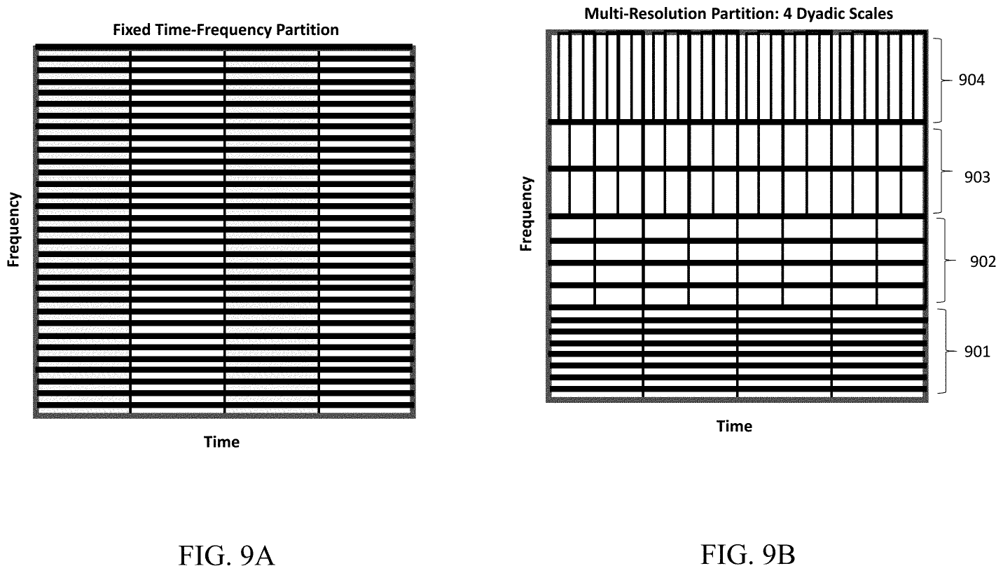

The encoder and decoder filters can have a fixed time-frequency partition resolution, as shown in FIG. 9A with a uniform time-frequency partitioning. However, examples of the present disclosure also include the use of a multi-resolution (e.g., non-uniform) time-frequency filters, such that the encoder and decoder filter-banks can be reconfigured to have varying time-frequency support. The use of multi-resolution filters can be reflective of human sound perception. For example, with low frequencies, humans perceive narrow frequency resolution, but broader time resolution (e.g., better tonal discrimination). And, with higher frequencies, human listeners perceive narrower time resolution, but broader frequency resolution (e.g., better identifying transient dynamics). FIG. 9B is an example of an encoder/decoder filter with 4 dyadic scales that reflect this aspect of human sound perception and can be used with aspects of the present disclosure. In FIG. 9B, the lowest frequencies 901 have narrow frequency bands but long time sampling. As frequencies, increase each of the next three bands 902, 903, 904 has decreasing time sampling but an increased frequency band. The multirate encoder and decoder improve the SEAMNET system's ability to encode the input signal into a perceptually relevant embedding space. During mask estimation, the system has better spectral resolution at lower frequencies, allowing improved discriminative ability between narrowband speech and noise components. Conversely, at higher frequencies, the system has better temporal resolution, allowing improved discriminative ability of transient speech and noise components.

Mask Estimation Network

The mask estimation network described above, and as shown, for example, in FIG. 4B, is using a time delay neural network (TDNN) having a sequence of fully-connected networks with 1D filtering and dilation across time. However, configuring the mask estimation network with a U-Net architecture, as shown in FIG. 10 allows for improved interaction between time-frequency components in the mask estimation procedure. The U-Net mask estimation network 1030 of FIG. 10 includes a plurality of FCNs that form a contracting path 1031 (e.g., downsampling) and a plurality of FCNs at form an expansive path 1039 (e.g., upsampling). Each path 1031, 1039 can follow the typical architecture of a convolutional network with each FCN step of the expansion path 1039 including a concatenation 1035 from the corresponding layers of the contracting path 1039. The U-Net architecture provides the mask estimation network with increasing amounts of temporal and spectral context at every downsampling step, allowing embeddings to capture speech at higher levels of abstraction. During the upsampling steps, the network rebuilds the original temporal and spectral resolution required to generate the final mask.

True Stereo Functionality

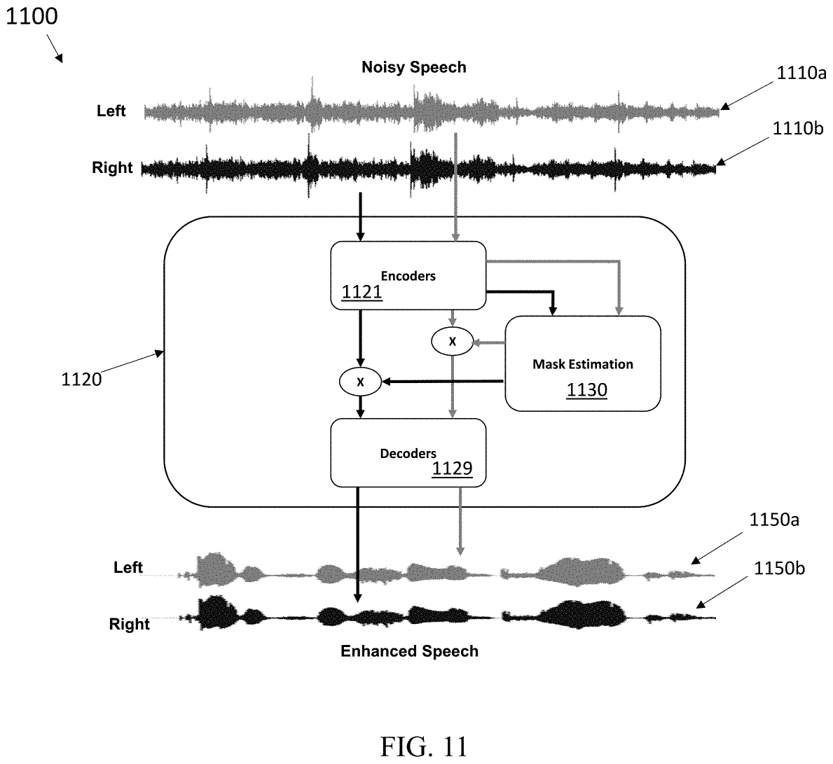

The b-net architectures described above (e.g. system 300 of FIG. 3A) were configured for single channel processing, and thus stereo signals would be processed using completely independent left and right channels. FIG. 11 shows an example multi-channel system 1100 with integrated stereo processing of two channels (e.g., Left and Right), and more can be added. The multi-channel system 1100 includes encoders 1121 receiving a left noisy speech waveform 1110a and a right noise speech waveform 1110b and decoders 1129 outputting a left enhanced speech waveform 1150a and a right enhanced speech waveform 1150b. The encoders 1121 and decoders 1129 can operate in a same or similar manner to those in a single-channel configuration. However, the multi-channel system 1100 also includes a mask estimation network 1130 that includes a DNN path for each channel. The channels of the stereo system share tied trainable weights, so that the processing applied to each is equivalent. During training, this allows the stereo system to learn an enhancement mapping applied to each input, while also learning to be robust to various cross-channel variation.” Additionally the multi-channel system 1100 can be trained using noisy speech modified to simulate a stereo environment.

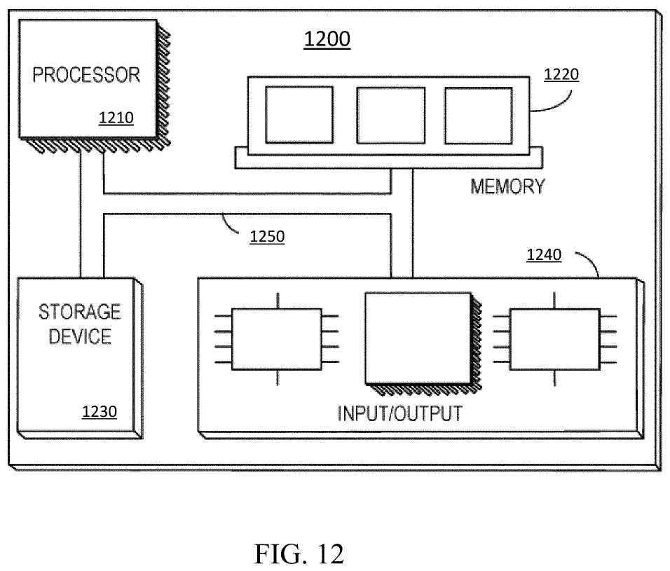

FIG. 12 provides for one non-limiting example of a computer system 1200 upon which the present disclosures can be built, performed, trained, etc. For example, referring to FIGS. 1B, 2A, 2B, 2C, 3A, 4A-D, 10A, 10B, and 11 the processing modules can be examples of the system 1200 described herein. The system 1200 can include a processor 1210, a memory 1220, a storage device 1230, and an input/output device 1240. Each of the components 1210, 1220, 1230, and 1240 can be interconnected, for example, using a system bus 1250. The processor 1210 can be capable of processing instructions for execution within the system 1200. The processor 1210 can be a single-threaded processor, a multi-threaded processor, or similar device. The processor 1210 can be capable of processing instructions stored in the memory 1220 or on the storage device 1230. The processor 1210 may execute operations such as extracting spectral features from an initial spectrum, training a deep neural network, executing an existing deep neural network, estimating noise, estimating signal-to-noise ratios, calculating gain masks, and/or generating an output spectrum, among other features described in conjunction with the present disclosure.

The memory 1220 can store information within the system 1200. In some implementations, the memory 1220 can be a computer-readable medium. The memory 1220 can, for example, be a volatile memory unit or a non-volatile memory unit. In some implementations, the memory 1220 can store information related to various sounds, noises, environments, and spectrograms, among other information.

The storage device 1230 can be capable of providing mass storage for the system 1200. In some implementations, the storage device 1030 can be a non-transitory computer-readable medium. The storage device 1230 can include, for example, a hard disk device, an optical disk device, a solid-date drive, a flash drive, magnetic tape, or some other large capacity storage device. The storage device 1230 may alternatively be a cloud storage device, e.g., a logical storage device including multiple physical storage devices distributed on a network and accessed using a network. In some implementations, the information stored on the memory 1220 can also or instead be stored on the storage device 1230.

The input/output device 1240 can provide input/output operations for the system 1200. In some implementations, the input/output device 1040 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, or a 4G wireless modem). In some implementations, the input/output device 1240 can include driver devices configured to receive input data and send output data to other input/output devices, e.g., a keyboard, a printer, and display devices (such as the GUI 12). In some implementations, mobile computing devices, mobile communication devices, and other devices can be used.

In some implementations, the system 1200 can be a microcontroller. A microcontroller is a device that contains multiple elements of a computer system in a single electronics package. For example, the single electronics package could contain the processor 1210, the memory 1220, the storage device 1230, and input/output devices 1240.

Although an example processing system has been described above, implementations of the subject matter and the functional operations described above can be implemented in other types of digital electronic circuitry, or in computer software, firmware, and/or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine readable propagated signal, or a combination of one or more of them.

Various embodiments of the present disclosure may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Examples of the present disclosure include:

1. A computer-implemented system for recognizing and processing speech, comprising:

a processor configured to execute an end-to-end neural network trained to detect speech in the presence of noise and distortion, the end-to-end neural network configured to receive an input waveform containing speech and output an enhanced waveform.

2. The system of example 1, wherein the end-to-end neural network defines a b-Net structure comprising an encoder path configured to map the input waveform into a sequence of input embeddings in which speech signal components and non-speech signal components are separable via a scaling procedure.
3. The system of example 2, wherein the encoder path comprises a single 1-dimensional convolutional neural network (CNN) layer with a plurality of filters and rectified linear activation functions.
4. The system of example 2 or 3, wherein the b-Net structure comprises a mask estimator configured to generate a sequence of multiplicative attention masks, the b-Net structure being configured to utilize the multiplicative attention masks to create a sequence of enhanced embeddings from the sequence of input embeddings.
5. The system of example 4, wherein the enhanced embeddings are generated as element-wise products of the input embeddings and the estimated masks.
6. The system of example 5, wherein the b-Net structure comprises a decoder path configured to synthesize an output waveform based on the sequence of enhanced embeddings.
7. The system of example 6, wherein the decoder path comprises a single 1-dimensional Transpose-CNN layer with an output filter configured to mimic overlap-and-add synthesis.
8. The system of any of examples 4 to 7, wherein the mask estimator comprises a cepstral extraction network configured to cepstral normalize an output from the encoder path.
9. The system of example 8, wherein the cepstral extraction network is configured to perform feature normalization and define a trainable extraction process that comprises a log operator and a 1×1 CNN layer.
10. The system of any of examples 4 to 9, wherein the mask estimator comprises a multi-layer fully convolutional network (FCN).
11. The system of example 10, wherein the FCN comprises a series of convolutional blocks, each comprising a CNN filter process, a batch normalization process, an activation process, and a squeeze and excitation network process (SENet).
12. The system of example 10 or 11, wherein the mask estimator comprises a frame-level voice activity detector layer.
13. The system of any of examples 4 to 12, wherein the end-to-end neural network is trained to estimate clean speech by minimizing a first cost function representing a distance between the output and an underlying clean speech signal.
14. The system of any of examples 4 to 13, wherein the end-to-end neural network is trained as an autoencoder to reconstruct the noisy input speech by minimizing a second cost function representing a distance between the input speech and the enhanced speech.
15. The system of any of examples 4 to 14, wherein the end-to-end neural network is trained to restrict enhancement to the masking estimator by minimizing a third cost function that represents a combination of distance between the output and an underlying clean speech signal and distance between the input speech and the enhanced speech such that, when the masking estimator is disabled, the output of the end-to-end neutral network is configured to recreate input waveform.
16. The system of any of examples 4 to 15, wherein the end-to-end neural network is trained to minimize a distance measure between a clean speech signal and reverberant-noisy speech signal using a target waveform according to Equation 16 with the majority of late reflections suppressed.
17. The system of any of examples 4 to 16, wherein the end-to-end neural network was trained using a generalized distance measure according to Equation 20.
18. The system of any of examples 4 to 17, wherein the end-to-end neural network is configured to be dynamically tuned via an input minimum gain threshold that controls a level of noise suppression present in the enhanced waveform.

The embodiments of the present disclosure described above are intended to be merely exemplary; numerous variations and modifications will be apparent to those skilled in the art. One skilled in the art will appreciate further features and advantages of the disclosure based on the above-described embodiments. Such variations and modifications are intended to be within the scope of the present invention as defined by any of the appended claims. Accordingly, the disclosure is not to be limited by what has been particularly shown and described, except as indicated by the appended claims. All publications and references cited herein are expressly incorporated herein by reference in their entirety.

What is claimed is:

1. A computer-implemented system for recognizing and processing speech, comprising:
a processor configured to execute an end-to-end neural network trained to detect speech in the presence of noise and distortion, the end-to-end neural network configured to receive an input waveform containing speech and output an enhanced waveform.

2. The system of claim 1, wherein the end-to-end neural network defines a b-Net structure comprising:
an encoder configured to map the input waveform into a sequence of input embeddings in which speech signal components and non-speech signal components are separable via a scaling procedure;
a mask estimator configured to generate a sequence of multiplicative attention masks, the b-Net structure being configured to utilize the multiplicative attention masks to create a sequence of enhanced embeddings from the sequence of input embeddings, and
a decoder configured to synthesize an output waveform based on the sequence of enhanced embeddings,
wherein the neural network comprises an autoencoder path and an enhancement path, the autoencoder path comprising the encoder and decoder and the enhancement path comprising the encoder, the mask estimator, and the decoder, and
wherein the neural network is configured to receive an input minimum gain that adjusts the relative influence between the autoencoder path and the enhancement path on the enhanced waveform.

3. The system of claim 2, wherein at least one of the encoder or the decoder comprises filter-banks configured to have non-uniform time-frequency partitioning.

4. The system of claim 2, wherein the end-to-end neural network is configured to process two or more input waveforms and output a corresponding enhanced waveform for each of the two or more input waveform, and wherein the mask estimator comprises a DNN path for each of the two or more input waveforms with shared layers between each path.

5. The system of claim 2, wherein the encoder comprises a single 1-dimensional convolutional neural network (CNN) layer with a plurality of filters and rectified linear activation functions.

6. The system of claim 2, wherein the enhanced embeddings are generated as element-wise products of the input embeddings and the estimated masks.

7. The system of claim 2, wherein the decoder comprises a single 1-dimensional Transpose-CNN layer with an output filter configured to mimic overlap-and-add synthesis.

8. The system of claim 2, wherein the mask estimator comprises a cepstral extraction network configured to cepstral normalize an output from the encoder.

9. The system of claim 6, wherein the cepstral extraction network is configured to perform feature normalization and define a trainable extraction process that comprises a log operator and a 1×1 CNN layer.

10. The system of claim 2, wherein the mask estimator comprises a multi-layer fully convolutional network (FCN).

11. The system of claim 10, wherein the FCN comprises a series of convolutional blocks, each comprising a CNN filter process, a batch normalization process, an activation process, and a squeeze and excitation network process (SENet).

12. The system of claim 10, wherein the mask estimator comprises a sequence of FCNs arranged as time-delay neural network (TDNN).

13. The system of claim 10, wherein the mask estimator comprises a plurality of FCNs arranged as a U-Net architecture.

14. The system of claim 10, wherein the mask estimator comprises a frame-level voice activity detector layer.

15. The system of claim 4, wherein the end-to-end neural network is trained to estimate clean speech by minimizing a first cost function representing a distance between the output and an underlying clean speech signal.

16. The system of claim 15, wherein the end-to-end neural network is trained as an autoencoder to reconstruct the noisy input speech by minimizing a second cost function representing a distance between the input speech and the enhanced speech.

17. The system of claim 16, wherein the end-to-end neural network is trained to restrict enhancement to the mask estimator by minimizing a third cost function that represents a combination of distance between the output and an underlying clean speech signal and distance between the input speech and the enhanced speech such that, when the mask estimator is disabled, the output of the end-to-end neutral network is configured to recreate input waveform.

18. The system of claim 2, wherein the end-to-end neural network is trained to minimize a distance measure between a clean speech signal and reverberant-noisy speech signal using a target waveform according to Equation 16 with the majority of late reflections suppressed.

19. The system of claim 2, wherein the end-to-end neural network was trained using a generalized distance measure according to Equation 20.

20. The system of claim 2, wherein the end-to-end neural network is configured to be dynamically tuned via the input minimum gain threshold to control a level of noise suppression present in the enhanced waveform.

21. A method for training a neural network for detecting the presence of speech, the method comprising:
constructing an end-to-end neural network configured to receive an input waveform containing speech and output an enhanced waveform, the neural network comprising an autoencoder path and an enhancement path, the autoencoder path comprising an encoder and a decoder and the enhancement path comprising the encoder, a mask estimator, and the decoder, wherein the neural network is configured to receive an input minimum gain that adjusts the relative influence between the autoencoder path and the enhancement path on the enhanced waveform; and
simultaneously training both the autoencoder path and the enhancement path using a loss function that includes a perceptually-motivated waveform distance measure.

22. The method of claim 21, comprising:
training the neural network to estimate clean speech by minimizing a first cost function representing a distance between the output and an underlying clean speech signal;
training the neural network as an autoencoder to reconstruct the noisy input speech by minimizing a second cost function representing a distance between the input speech and the enhanced speech, and
training the neural network to restrict enhancement to the mask estimator by minimizing a third cost function that represents a combination of distance between the output and an underlying clean speech signal and distance between the input speech and the enhanced speech such that, when the mask estimator is disabled, the output of the end-to-end neutral network is configured to recreate input waveform.

23. The method of claim 21, wherein simultaneously training both the autoencoder path and the enhancement path comprises minimizing a distance measure between a clean speech signal and reverberant-noisy speech signal using a target waveform according to Equation 16 with the majority of late reflections suppressed.
